(19) United States
(12) Patent Application Publication
(10) Pub. No.: US 2014/0181941 A1
(43) Pub. Date: Jun. 26, 2014

(54) METHOD AND APPARATUS FOR A SECURE PUBLIC IDENTIFICATION TAG

(71) Applicant: Christina R. Quint, Lenexa, KS (US)

(72) Inventor: Christina R. Quint, Lenexa, KS (US)

(21) Appl. No.: 14/139,430

(22) Filed: Dec. 23, 2013

Related U.S. Application Data
(60) Provisional application No. 61/740,981, filed on Dec. 21, 2012.

(51) Int. Cl. H04L 29/06

(52) U.S. Cl. CPC H04L 63/08
USPC 726/7

(57) ABSTRACT

A method and apparatus for a secure public identification tag on a sticker, bracelet or temporary tattoo, or other temporary tag. The tag includes a two-dimensional bar code with embedded public key and a removable or separable security code. The two-dimensional bar code, such as a QR code, a Maxicode, a High Capacity Color Bar Code, an Aztec Code, or any code capable of being scanned may be used. The two-dimensional bar code includes the URL address to a secure website and the public identification. When the bar code is scanned for the first time the user is provided with a registration screen to enter the security code and information that may be publicly viewed, as well as a time limit for expiration of the identification tag. When the identification tag is subsequently scanned only the public information may be viewed unless the security code is entered.

### CROSS-REFERENCE TO RELATED APPLICATION

This application claims the benefit of co-pending application Ser. No. 61/740,981, filed on Dec. 21, 2012, entitled METHOD AND APPARATUS FOR A SECURE PUBLIC IDENTIFICATION TAG

### FIELD

The present invention generally relates to a method and apparatus for a secure public identification tag and, more particularly, to a method and apparatus for a secure public identification tag that may be publicly worn without disclosing private information and which may be temporal.

### BACKGROUND

ID tags are well known in the prior art. ID tags may be preprinted with a wearer's name and other identifying information. Such ID tags are commonly referred to as name tags, identification (“ID”) tags or ID bracelets, for example. Name tags may be durable and designed to be worn repeatedly, and temporarily attached to the wearer's clothing. Other name tags are disposable and intended for a one-time use with the wearer's name preprinted or handwritten on an adhesive-backed label, which may be temporarily affixed or stuck on the wearer's clothing. The identity, i.e., name of the wearer or other information on the tag, is readily viewable by others.

ID bracelets may be placed around a wearer's wrist or ankle and may include information such as the wearer's name, date of birth, phone number, or other personal information. ID bracelets may be durable and worn repeatedly. ID bracelets may also be temporarily worn or designed to be worn one time and then disposed of when removed. Other ID bracelets may include no personal information, but be color coded to signify the age of the wearer or to indicate that the wearer is permitted to have access to a particular event or area, for example, or are old enough to purchase and/or consume alcohol. Other ID tags may be in the form of a temporary stamp that is applied to the back of a person's hand to indicate that the person has paid to enter an area or event, for example.

ID tags for children may be used to readily identify a lost child and help return the child to his or her parents or guardian. These tags may include information such as the child's name and a phone number to call, such as a parent's phone number, if the child is lost or separated from his or her parents. A problem with these types of ID tags is a third party predator may use the available information to exploit or abduct the child. A predator may befriend an unwitting child by using the child's name learned from the child's ID tag, causing the child to believe that the person knows the child. ID bracelets with readily viewable information may also allow the wearer to be exploited by an unscrupulous person.

### SUMMARY

The present invention includes a method and apparatus for a secure public identification tag. The tag may be a sticker, bracelet or temporary tattoo, for example. The tag includes a two-dimensional bar code with embedded public key and a removable or separable security code.

The two-dimensional bar code, such as a QR code, a Maxicode, a High Capacity Color Bar Code, an Aztec Code, or any code capable of being scanned may be used. The two-dimensional bar code includes the URL address to a secure website and the public identification. When the bar code is scanned for the first time the user is provided with a registration screen to enter the security code and information that may be publicly viewed, as well as a time limit for expiration of the identification tag. When the identification tag is subsequently scanned, only the public information may be viewed, unless the security code is entered.

### BRIEF DESCRIPTION OF THE DRAWINGS

FIG. 1 is an illustration of a secure identification tag of the present invention.

FIGS. 2 and 3 are illustrations of a wristband secure identification tag of the present invention.

FIGS. 4 and 5 illustrate an initial scan and setup for a secure identification tag.

FIG. 6 illustrates a subsequent scan of the secure identification tag.

FIG. 7 is a flow chart illustrating an embodiment of a secure identification tab method of the present invention.

FIG. 8 is a functional block diagram illustrating an embodiment of a secure identification tag method of the present invention.

### DESCRIPTION

As required, detailed embodiments of the present invention are disclosed herein. However, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

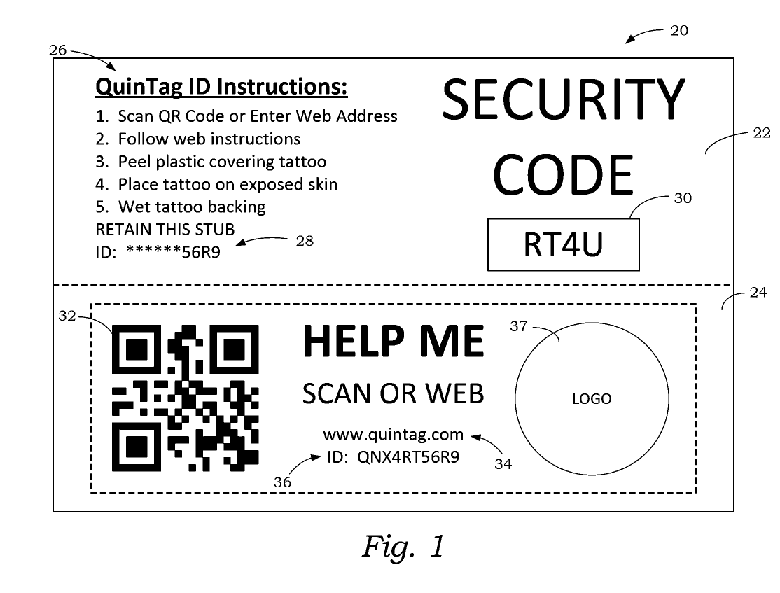

Referring initially to FIG. 1, a secure identification tag of the present invention is indicated by reference numeral 20. The secure identification tag 20 is a two-part tag including an upper portion 22 and a lower portion 24. The upper portion 22 is separable or detachable from the lower portion 24. The upper portion 22 may include a set of instructions 26 for activating the secure identification tag 20 and for applying the tag as is appropriate for the particular tag securing mechanism, a partial identification 28 and a security code 30. For example, as illustrated in FIG. 1, the secure identification tag 20 embodiment is a temporary tattoo to be applied to the wearer's skin (see instructions 26).

The lower portion 24 may include a bar code or QR code 32, a website address 34 and a public key or ID 36. The bar code 32 may include an encoded website address 34 and the public key 36. An advertising sponsor's logo 37 may also be included on the lower portion 24.

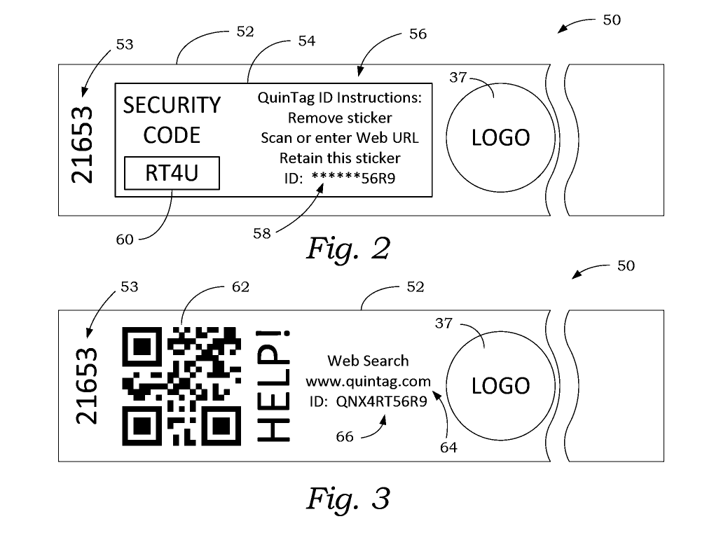

Referring to FIGS. 2 and 3, another example of a secure identification tag is indicated by reference numeral 50. The secure identification tag 50 may be in the form of a wrist band 52, such as a plastic, Tyvek® or other wrist band, for example, with a serial number 53 and a removable sticker 54. The removable sticker includes instructions 56 for activating the secure identification tag 50, and for attaching the wrist band 52 to a wearer's wrist or ankle, a partial identification 58, and a security code 60.

When the removable sticker 54 is removed additional information is exposed, such as a bar code or QR code 62, a website address 64, and a public key 66. The bar code 62 may include an encoded website address 64 and the public key 66.

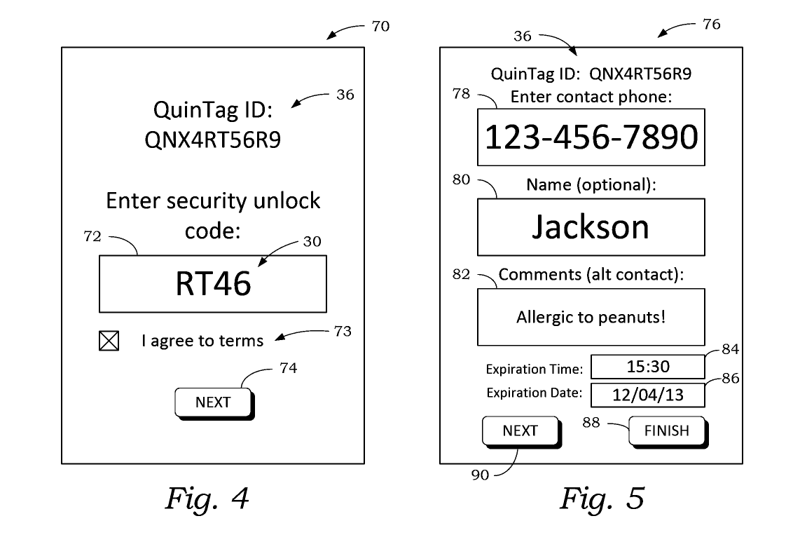

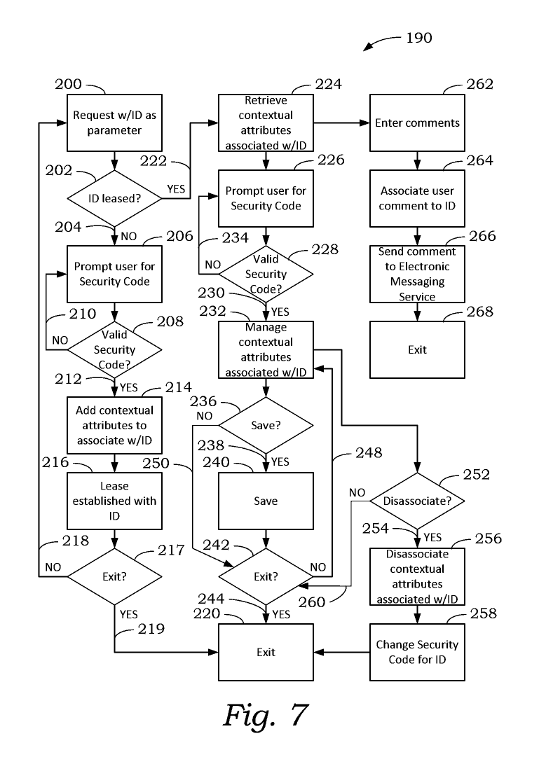

Referring to FIGS. 1 and 4-7, an embodiment of a method of the present invention is generally indicated by reference numeral 190 (FIG. 7). A user initially scans the QR code 32 with a scanner or scanner app commonly loaded on a smart phone, which directs the user to a scan web page 70. The request includes the ID 36 as a parameter 200. The system first determines if the ID is already leased 202. If the ID 36 is not leased 204, then the user is prompted 206 to enter the security code 30 into the security code box or field 72. Once the security code 30 is entered, the user may be required to agree to the terms of use of the system 73. If the user selects Next 74, the system attempts to validate the security code 30 and ID 36 combination 208. If the security code 30/ID 36 combination entered does not match 210 indicating an invalid security code, an error message may be displayed and the user is again prompted to enter a security code 206. If the security code 30/ID 36 combination entered matches 212, then a screen is displayed 76 and the user is prompted to enter contextual attributes to associate with the ID 214. Contextual attributes may include information such as a phone number 78, a name 80, other comments 82, an expiration time 84, and expiration date 86, for example.

After the contextual attributes are entered 214, the user may select Finish 88, to associate the contextual information with the ID and lease the secure ID 216. The user then is given the option to exit 217. If the user chooses to exit 219, the user is logged off and the system exits 220.

If the user chooses to not exit 218, the user may select Next 90 to lease the ID 216 and return to the beginning 200 to manage an existing ID lease or establish a new ID lease, for example. Once the lease is established, the user may utilize near field communication (NFC) to transfer the contextual information for the secure ID to another smart phone or device by touching the devices together or bring them into close proximity.

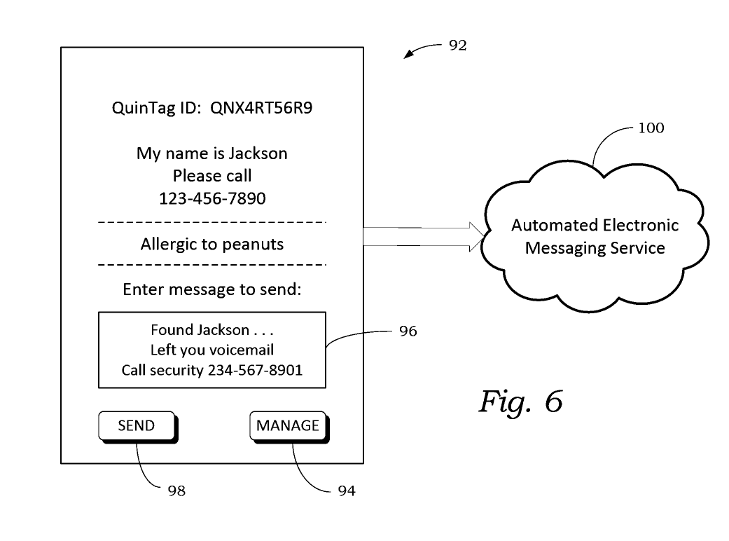

Returning to block 202, if the ID is leased 222, then some or all of the contextual information entered for this ID is retrieved 224 and displayed 92 (FIG. 6). If the user selects Manage 94, the user is prompted to enter the security code 226. The security code is then checked to determine if it is valid 228. If valid 230, the contextual information is displayed 92. If not valid 234, processing returns to block 226. If the contextual information is changed, the user is given the option to save the contextual information 236. If the user decides to save the contextual information 238, the information is saved 240, and the user is given the option to exit 242. If the user decides to exit 244, processing is terminated 220. If the user decides to not exit 248, processing returns to block 232. If the user does not want to save the contextual information 250, processing continues at block 242.

From the manage contextual information block 232, the user is also given the option of disassociating the contextual information and the secure ID 252. If the user wants to disassociate the contextual information and the ID 254, the data record associating the ID with the contextual attributes is deleted or otherwise disassociated 256, the security code for the ID is changed 258 and processing exits 220.

If disassociation of the identification and contextual information is not selected 260, processing continues at block 242.

Returning to block 224, the user may enter a comment or text 262 in a message field 96 and select Send 98. The text message entered into the message field 96 is associated with the secure ID 264 and sent to the messaging service 266 originally set up by the user. This may include any automated electronic messaging service 100 such as SMS, email, Twitter® or a posting Facebook®, for example. Other information such as the current GPS location coordinates or other location parameters may also be sent. Once the information is sent, processing exits 268.

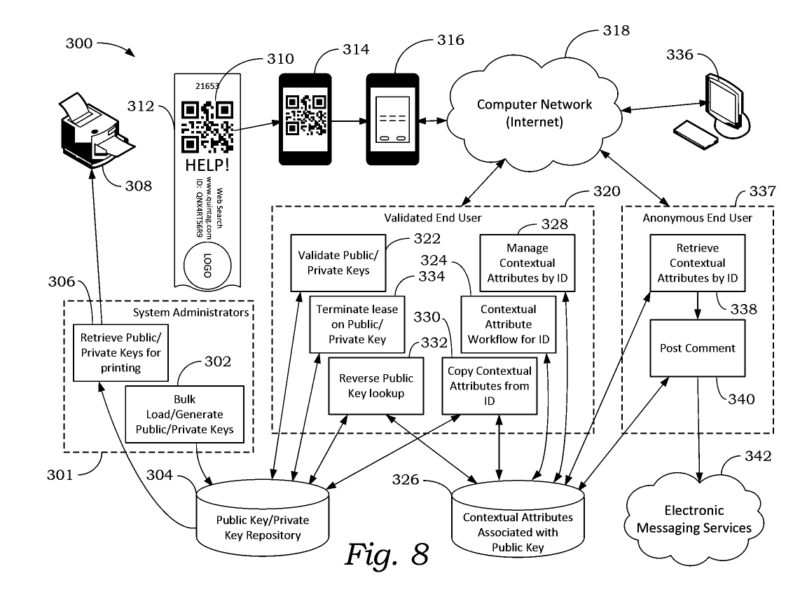

Referring to FIG. 8, a system diagram is generally indicated by reference numeral 300. Initially, a system administration system 301 generates private and public key combinations 302, which are stored in a key database 304. The keys are retrieved 306 from the database 304 for printing 308 on a tag or bracelet 312 (see also FIGS. 1 and 2).

When a bar code 310 on a tag or bracelet 312 is scanned by a smart phone 314 or other scanning device, the scanning device navigates to the associated website 316 through the internet 318 to access the system functions 320. When a security code is entered, the system retrieves the public key/private key information from the key database 304 to validate the key pair 322. If a key pair is validated, contextual information may be entered for association with the public key 324 and stored in a contextual database 326. The user may then manage the contextual information associated with the ID 328, copy contextual information from one validated public/private key pair to another public key 330, reverse public key lookup 332 to view the public contextual attributes of a public key and to terminate a lease on a public/private key 334.

An anonymous user or third party 337 may access the secure ID website using any browser-based device 336, through the internet 318 by entering an ID public key or by scanning the QR code 310. The contextual attributes associated with the public key are retrieved 338 from the contextual database 326 and displayed. The third party may then post a comment or text 340, which is stored in the contextual database 326 and sent to a messaging system 342 for dissemination as configured by the validated end user.

It is to be understood that while certain now preferred forms of this invention have been illustrated and described, it is not limited thereto except insofar as such limitations are included in the following claims.

Having thus described the invention, what is claimed as new and desired to be secured by Letters Patent is as follows:

1. A method executed on a computer processor comprising:
scanning a machine readable code on a tag, said machine readable code including an ID;
entering a security code associated with said ID;
validating said security code and said ID combination with a stored security code and stored ID from a key database;
associating contextual attributes with said ID; and
storing said contextual attributed associated with said ID in a public database.

2. The method of claim 1 further comprising:
scanning a said machine readable code; and
retrieving said contextual attributes associated with said ID from said public database.

3. The method of claim 2 further comprising:
scanning a said machine readable code;
entering comments; and
posting said comments to an electronic messaging service.

4. The method of claim 2 further comprising:
scanning a said machine readable code;
entering said security code associated with said ID;
retrieving said contextual attributes associated with said ID from said public database;
editing said contextual attributes associated with said ID; and
storing said edited contextual attributed associated with said ID in a public database.

5. The method of claim 2 further comprising:
scanning a said machine readable code;
entering said security code associated with said ID;
disassociating said security code and said ID;
changing the security code for said ID; and
storing said changed security code and said ID in said key database.

6. The method of claim 1 further comprising setting a lease term for said security code and said ID combination.

7. The method of claim 6 further comprising disassociating said security code and said ID upon expiration of lease term.

8. A method executed on a computer processor comprising:
entering a website address on an internet connected device;
navigating to said website associated with said website address;
entering an ID and a security code;
entering a security code associated with said ID,
validating said security code and said ID combination with a stored security code and stored ID from a key database,
associating contextual attributes with said ID, and
storing said contextual attributed associated with said ID in a public database.

9. The method of claim 8 further comprising:
scanning a said machine readable code including said ID, and
retrieving said contextual attributes associated with said ID from said public database.

10. The method of claim 9 further comprising:
scanning a said machine readable code,
entering comments, and
posting said comments to an electronic messaging service.

11. The method of claim 9 further comprising:
scanning a said machine readable code,
entering said security code associated with said ID,
retrieving said contextual attributes associated with said ID from said public database,
editing said contextual attributes associated with said ID, and
storing said edited contextual attributed associated with said ID in a public database.

12. The method of claim 9 further comprising:
scanning a said machine readable code,
entering said security code associated with said ID,
disassociating said security code and said ID,
changing the security code for said ID, and
storing said changed security code and said ID in said key database.

13. The method of claim 8 further comprising setting a lease term for said security code and said ID combination.

14. The method of claim 13 further comprising disassociating said security code and said ID upon expiration of lease term.
